(19) United States
(12) Patent Application Publication
(10) Pub. No.: US 2012/0292933 A1
(43) Pub. Date: Nov. 22, 2012

(54) POOPER SCOOPER WITH ILLUMINATING LIGHT

(76) Inventor: Jay M. Krupp, Buffalo Grove, IL (US)

(21) Appl. No.: 13/112,310

(22) Filed: May 20, 2011

(51) Int. Cl. A01K 29/00

(52) U.S. Cl. 294/1.4

(57) ABSTRACT

An apparatus for disposing of pet fecal matter has an elongated frame member, a receptacle device mounted on a lower end of the elongated frame member and operable between an open and a closed position, a first handle affixed to an upper section of the frame, a second handle operably mounted on the upper section of the elongated frame member and movable between two positions relative to the frame and the first handle and operably connected to the receptacle device to open and close the receptacle. An illumination device is mounted on the elongated frame member and constructed to direct light downward to the receptacle device to illuminate the receptacle device and the ground in vicinity to and about the receptacle device.

### TECHNICAL FIELD

The field of this invention relates to an improved pet waste removal device commonly known as a pooper scooper.

### BACKGROUND OF THE DISCLOSURE

Many municipalities and other government entities require that pet fecal matter be removed from all outdoor public. The laws and regulations promote good health habits and a desirable neighborhood policy by requiring removal of pet fecal matter from public property and neighborhood lawns and gardens. However, cleaning up fecal matter can be inconvenient and smelly. Many types of pooper scoopers have been devised to eliminate the need for a pet owner to bend down for picking up pet fecal matter. These pooper scoopers also do a good job of maintaining distance between the pet owner's nose and the fecal matter thereby eliminating the smell from picking up the fecal matter.

However, many pets require to be walked at night and many pet owners face the task of walking pet dogs at night in the dark with inadequate street illumination. It is inconvenient for the pet owner to hold a separate flashlight because he is already commonly holding a leash for the dog in one hand and the pooper scooper in the other hand. While several pooper scoopers have been devised with lights, none of them provide adaptability or adjustment to meet the personal requirements of each pet owner.

What is needed is an improved pooper-scooper with an illumination device that does not interfere with the operation of the pooper scooper and provides a degree of adjustment for use when walking and when picking up fecal matter.

### SUMMARY OF THE DISCLOSURE

In accordance with one aspect of the invention, an apparatus for disposing of pet fecal matter has an elongated frame member, a receptacle device mounted on a lower end of the elongated frame member and operable between an open and a closed position, a first handle affixed to an upper section of the frame, a second handle operably mounted on the upper section of the elongated frame member and movable between two positions relative to the frame and the first handle and operably connected to the receptacle device for opening and closing the receptacle device.

An illumination device is mounted on a midsection of the elongated frame member and is constructed to direct light downward to the receptacle device to illuminate the receptacle device and the ground in vicinity to and about the receptacle device.

Preferably, the illumination device is adjustably mounted axially along the midsection of the elongated frame to adjust the spread of the beam onto the ground. The elongated frame is in the form of a hollow tube. The second handle is operably connected to the receptacle device through the hollow tube. The illumination device is mounted by a collar about the hollow tube.

Preferably, the illumination device is an LED light and has an on-off switch thereon. The collar and light are pivotably mounted together to allow the illumination device to throw either a vertical beam or horizontal beam. The receptacle device is spring biased to a closed position. The second handle is spaced from and parallel to the first handle such that squeezing the second handle and first handle together opens the receptacle.

### BRIEF DESCRIPTION OF THE DRAWINGS

Reference now is made to the accompanying drawings in which:

FIG. 1 is perspective view of a pooper-scooper in accordance with one embodiment of the invention;

FIG. 2 is a side partially segmented view of the pooper scooper shown in FIG. 1 in the closed position;

FIG. 3 is a view similar to FIG. 2 showing the pooper scooper in the open position; and

FIG. 4 is a perspective view showing the illuminating light focused directly on the shovel jaws.

### DETAILED DESCRIPTION OF THE PREFERRED EMBODIMENT

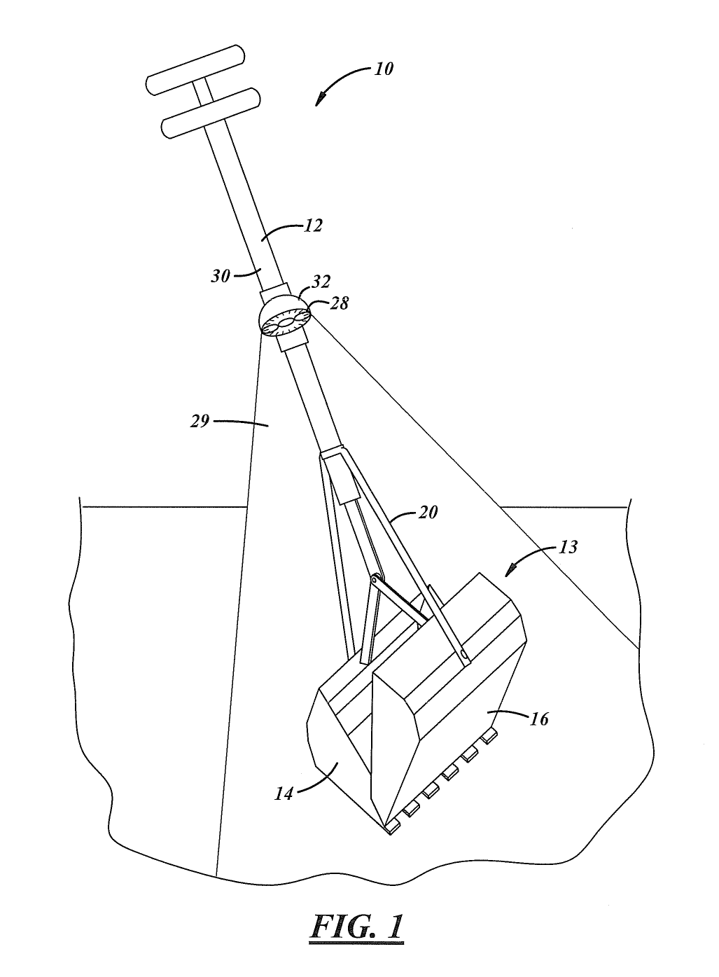

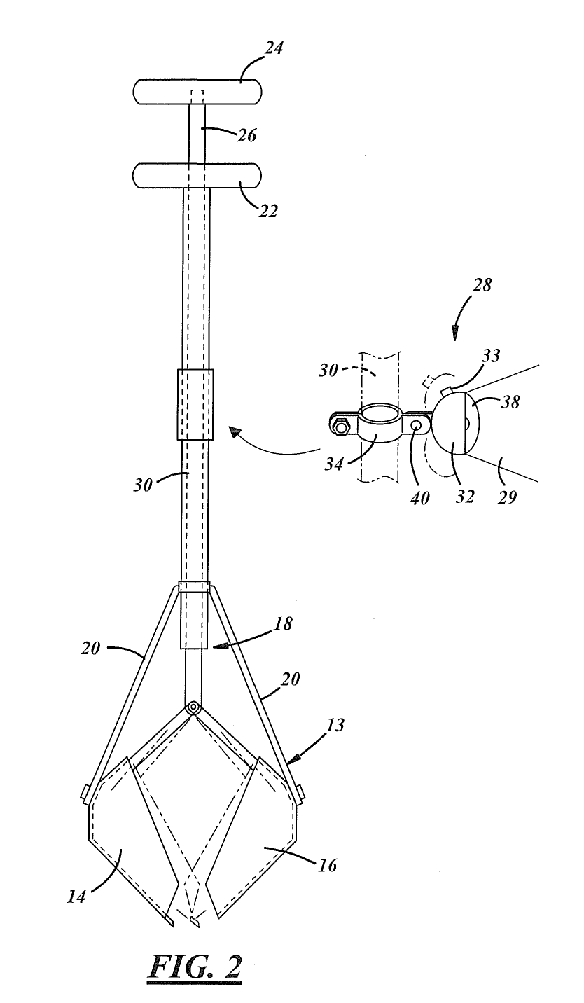

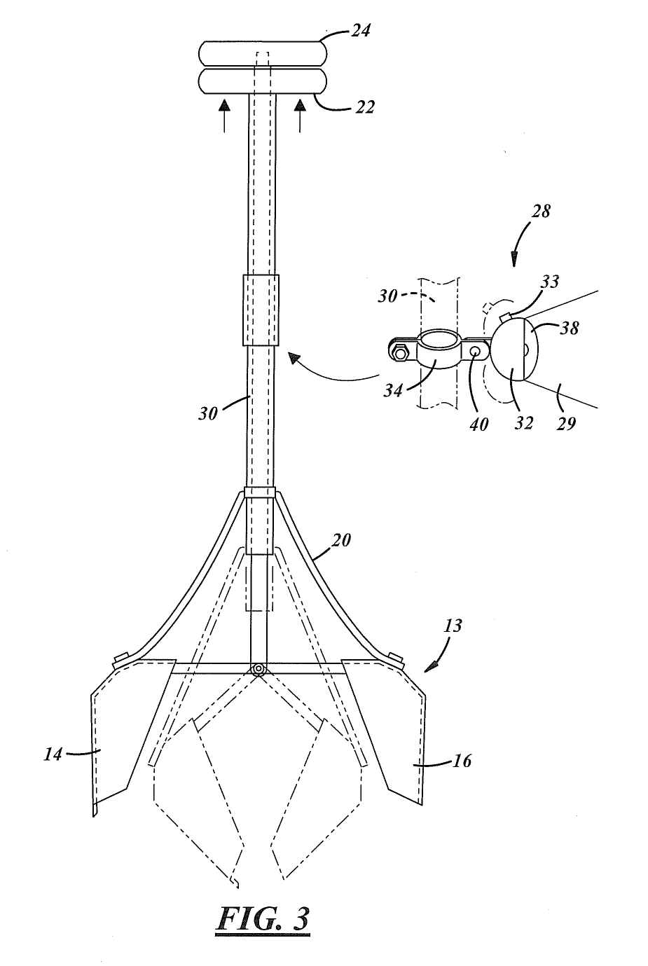

Referring now to FIG. 1, a pooper-scooper 10 has an elongated frame in the form of a hollow tube 12. A receptacle device 13 in the form of a shovel with left and right jaws 14, and 16 that are operably mounted at the lower end 18 of the hollow tube 12 for being movable between a closed position shown in FIG. 2 and an open position shown in FIG. 3. The jaws 14 and 16 may be spring biased to the closed position via spring elements 20.

A first handle 22 is affixed to the upper end of the hollow tube 12. A second handle 24 is connected via linkage 26 that extends through the hollow tube 12 to operate the receptacle device 13 between the open and closed positions. The handles 22 and 24 are spaced apart and parallel to each other. The handle 24 is normally in the spaced position shown in FIG. 2. When handles 22 and 24 are squeezed together, the linkage 26 moves with respect to tube 12 and opens the receptacle device 13.

An LED light 28 is mounted about a midsection 30 of the tube 12. The LED light may have a protective housing 32 that is pointed in the downward direction to shine upon the receptacle device 13 and ground in the vicinity of the receptacle device 13. The protective housing 32 may contain a suitable battery pack and circuitry. An operable on-off switch 33 is also mounted on the protective housing 32. The protective housing 32 is mounted to a mounted collar 34 that is clamped about midsection 30 the tube 12. The collar may be loosened to be adjusted up and down the midsection 30 of the tube 12.

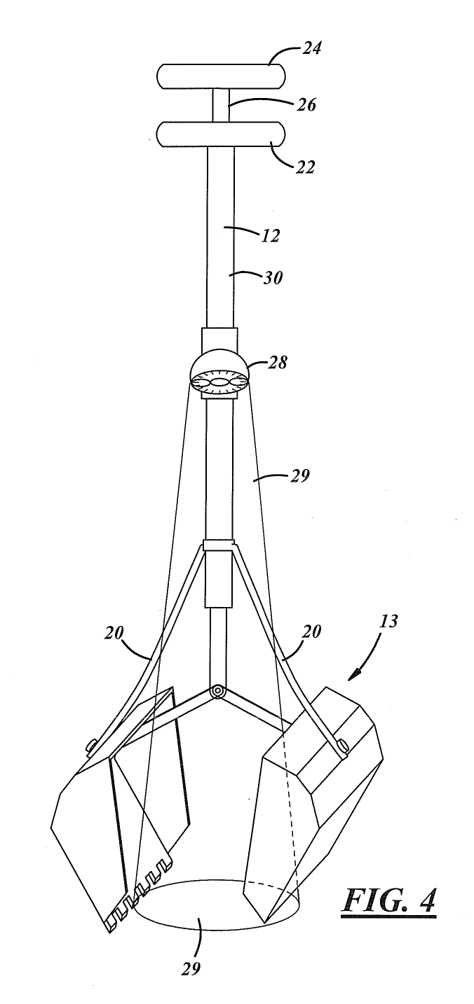

For example, during walking, the LED light 28 may be moved upwardly on tube 12 to adjust the spread of the light beam 29 in order to provide a wider beam that illuminates an entire width of a paved sidewalk. During waste collection, the collar may be slid downwardly to focus the light beam more brightly onto the receptacle and on the ground in the vicinity and about the receptacle device to illuminate onto the fecal matter to be picked up into the receptacle device as shown in FIG. 4.

The collar 34 does not interfere with the operation of the linkage 26 which passes through the collar 34 of the LED light 28. While a LED light is shown, other types of lights are usable, for example incandescent or fluorescent light sources. The LED light, if desired, may be equipped to flash or have different colored lights for an enhanced safety indicator at night.

Alternatively or in addition to sliding along tube 12, the housing 32 may have a focusing lens 38 that can be rotated in a threaded connection with housing 32 or have a slide connection with housing 32 to change the focus of the light from a wide beam as shown in FIG. 1 to a narrow beam as shown in FIG. 4.

The light housing 32 may also be pivotably mounted to the collar 34 through pivot point 40 to allow the light to be adjusted horizontally for walking or vertically to shine on the receptacle device 13.

While the receptacle device 13 shown is a jaw like device, other working receptacle devices are foreseen, for example, disposable bags mounted on spring arms or clamping members that close the top of a bag. While handles 22 and 24 are shown as bar-like devices, other forms such as levers, triggers or operable buttons may also be used.

In this fashion, a pet owner can easily carry a pooper scooper with a light and his leashed dog. The light 28, when on, can help locate fecal matter in the dark and also help illuminate and operate the receptacle device 13 to assure that the fecal matter gets into the receptacle device. Furthermore, the light may be adjusted to provide a walking light at night.

Other variations and modifications are possible without departing from the scope and spirit of the present invention as defined by the appended claims.

The embodiments in which an exclusive property or privilege is claimed are defined as follows:

1. An apparatus for disposing of pet fecal matter, said apparatus comprising:
an elongated frame member;
a receptacle device mounted on a lower end of said elongated frame member and operable between an open and a closed position;
a first handle affixed to an upper section of said frame;
a second handle operably mounted on the upper section of said elongated frame member and movable between two positions relative to said frame and said first handle and operably connected to said receptacle device to open and close said receptacle device; and
an illumination device mounted on a midsection of said elongated frame member and constructed to direct light downward to the receptacle device to illuminate the receptacle device and the ground in vicinity to and about said receptacle device.

2. An apparatus as defined in claim 1 further comprising:
said illumination device being adjustably mounted axially along said midsection of said elongated frame to adjust the spread of the beam onto the ground.

3. An apparatus as defined in claim 2 further comprising:
said elongated frame being in the form of a hollow tube;
said second handle being operably connected to said receptacle device through said hollow tube; and
said illumination device being mounted by a collar about said hollow tube.

4. An apparatus as defined in claim 3 further comprising:
said illumination device being an LED light and having an on-off switch thereon; and having a pivotable mount to said collar for pivotably adjusting to throw a vertical beam or a horizontal beam.

5. An apparatus as defined in claim 4 further comprising:
said receptacle device being spring biased to a closed position;
said second handle being spaced from and parallel to said first handle such that squeezing said second handle toward said first handle opens said receptacle.

6. An apparatus as defined in claim 1 further comprising:
said illumination device having a lens that is adjustable to adjust the spread of the light beam.

7. An apparatus as defined in claim 1 further comprising:
said elongated frame being in the form of a hollow tube;
said second handle being operably connected to said receptacle device through said hollow tube; and
said illumination device being mounted by a collar about said hollow tube.

8. An apparatus as defined in claim 7 further comprising:
said illumination device being an LED light having an on-off switch thereon and having a pivotable mount to said collar for pivotably adjusting to throw a vertical beam or a horizontal beam.

9. An apparatus as defined in claim 8 further comprising:
said illumination device having a lens that is adjustable to adjust the spread of the light beam.

10. An apparatus as defined in claim 8 further comprising:
said receptacle device being spring biased to a closed position;
said second handle being spaced from and parallel to said first handle such that squeezing said second handle toward said first handle opens said receptacle.

11. An apparatus for disposing of pet fecal matter, said apparatus comprising:
an elongated frame member;
a receptacle device mounted on a lower end of said elongated frame member and operable between an open and a closed position;
a first handle affixed to an upper section of said frame;
a second handle operably mounted on the upper section of said elongated frame member and movable between two positions relative to said frame and said first handle and operably connected to said receptacle device to open and close said receptacle device;
an illumination device mounted on said elongated frame member and constructed to direct light downward to the receptacle device to illuminate the receptacle device and the ground in vicinity to and about said receptacle device; and
an adjustment mechanism for adjusting the spread of the light beam on the receptacle device and the ground in vicinity to and about said receptacle device.

12. An apparatus as defined in claim 11 further comprising:
said illumination device being adjustably mounted axially along said midsection of said elongated frame to adjust the spread of the beam onto the ground.

13. An apparatus as defined in claim 12 further comprising:
said elongated frame being in the form of a hollow tube;
said second handle being operably connected to said receptacle device through said hollow tube; and
said illumination device being mounted by a collar about said hollow tube.

14. An apparatus as defined in claim 13 further comprising:
said illumination device being an LED light having an on-off switch thereon and having a pivotable mount to said collar for pivotably adjusting to throw a vertical beam or a horizontal beam.

15. An apparatus as defined in claim 11 further comprising:
said illumination device having a lens that is adjustable to adjust the spread of the light beam.

16. An apparatus as defined in claim 15 further comprising:
said illumination device being an LED light having an on-off switch thereon and having a pivotable mount to said collar for pivotably adjusting to throw a vertical beam or a horizontal beam.
